(19) United States
(12) Patent Application Publication
(10) Pub. No.: US 2012/0183341 A1
(43) Pub. Date: Jul. 19, 2012

(54) Printing Apparatus And Controlling Method Therefor

(75) Inventors: Toshinori TAKAHASHI, Kawasaki-shi (JP); Yasumitsu HIRAIWA, Zama-shi (JP); Osamu GOTO, Yokohama-shi (JP); Kei SUZUKI, Yokosuka-shi (JP); Hiroyuki UEDA, Yokohama-shi (JP); Kazuhiro NOMURA, Machida-shi (JP); Hiroshi NISHIUMI, Yokohama-shi (JP)

(73) Assignee: JVC KENWOOD Corporation, Kanagawa (JP)

(21) Appl. No.: 13/350,900

(22) Filed: Jan. 16, 2012

(30) Foreign Application Priority Data
Jan. 18, 2011 (JP) 2011-008178
Sep. 26, 2011 (JP) 2011-209026

(51) Int. Cl. B41J 33/14

(52) U.S. Cl. 400/225

(57) ABSTRACT

A printing apparatus for printing an image on a printing object on the basis of input data is composed of a printing mechanism for compressing an ink ribbon against a printing object and forming an image in accordance with input data on the printing object, a controlling section for controlling the printing mechanism so as to form a rotated image by 180 degrees for second printing conducted in succession to first printing for printing a not rotated image, and a driving mechanism for rewinding the ink ribbon extended between supply and take-up rolls to the supply roll during the first printing and second printing.

### CROSS-REFERENCE TO RELATED APPLICATION

This application is based on and claims the benefit of priority from the prior Japanese Patent Application No. 2011-008178, filed on Jan. 18, 2011 and No. 2011-209026, filed on Sep. 26, 2011, the entire content of which is incorporated herein by reference.

### BACKGROUND OF THE INVENTION

1. Field of the Invention

This invention relates to a printing apparatus and a controlling method therefore, particularly, relates to a printing apparatus utilizing an ink ribbon and a controlling method for the printing apparatus utilizing an ink ribbon.

2. Description of the Related Art

Currently, a printing apparatus utilizing a thermal transfer type ink ribbon is commonly used. In case of performing color printing by utilizing a thermal transfer type ink ribbon, such an ink ribbon for color printing is provided with a yellow panel, a magenta panel and a cyan panel.

Utilizing such an ink ribbon repeatedly a plurality of times is most important improvement for environmental burden as well as for printing cost. However, in a thermal transfer type printing apparatus, in case an already used part of an ink ribbon is reused a plurality of times for the purpose of reducing printing cost, printing quality is deteriorated in ink concentration, and resulting in obtaining inaccurate printed matter such as uneven print density. Particularly, in case of color printing, it is apparent that picture quality is degraded furthermore.

One of printing apparatuses utilizing an ink ribbon is disclosed in the Japanese publication of unexamined patent application No. 10-329346.

The printing apparatus disclosed in the Japanese publication No. 10-329346 conducts following processes so as to use an ink ribbon efficiently. Firstly, each panel provided on an ink ribbon is divided into a plurality of sectors, and sector control information, which indicates whether or not a sector is used, is recorded in a mark recording region corresponding to the sector. By using the sector control information, a sector available for printing is searched. When an available sector is searched, a printing device is relatively moved to a position on the ink ribbon where a sector is not used yet or a position of the available sector, and then printing is conducted at the position on the ink ribbon.

Further, in the printing apparatus disclosed in the Japanese publication No. 10-329346, by arranging a plurality of sectors in the lateral and longitudinal directions, one panel is divided into a matrix arrangement.

Furthermore, according to the paragraph [0079] in the Japanese publication No. 10-329346, image data to be printed is rotated in a microprocessor, and then a not used sector is used. In other words, by rewinding a ribbon supply role after the printing is once completed, a not used sector is used.

A printing apparatus utilizing an ink ribbon is some times applied for printing discrimination information on a card such as an identification (ID) card. For instance, character information such as name, discrimination number, address and age is printed on a card as discrimination information together with a facial photograph. In other words, discrimination information such as facial photograph is printed on a card as information inherent in the card.

In case of printing on a card such as an ID card, each printing layout of a plurality of cards is generally made to be uniform. In other words, the printing process for printing on a plurality of cards is conducted such that discrimination information including character information and facial information is printed in a same position on each of a plurality of cards approximately. However, each of contents of the discrimination information varies by each card.

With referring to FIG. 8, the printing process of discrimination information according to the prior art is depicted in detail next.

FIG. 8 is an explanatory drawing of printing process of discrimination information according to the prior art.

In FIG. 8, a card 800 is provided with a color printing area 801 in which a facial photograph is printed and a black-and-white printing area 802 in which some characters are printed. Yellow “Y”, magenta “M” and cyan “C” inks are used for printing in the color printing area 801, and a black “B” ink is used for printing in the black-and-white printing area 802. Consequently, an ink ribbon 900 is provided with a Y-panel 901 in yellow, a M-panel 902 in magenta, a C-panel 903 in cyan and a B-panel 904 in black in order repeatedly.

The card 800 shown in FIG. 8 is one example of an ID card. The card 800 is printed, for instance, in such a way that a facial photograph is printed in the color printing area 801 and name and discrimination number of a person are printed in the black-and-white printing area 802. In case of printing information on the card 800 as mentioned above, only a limited area of each panel on the ink ribbon 900 is used for printing.

Accordingly, such a printing method according to the prior art fails to be able to use an ink ribbon efficiently.

Further, in the case of the printing method disclosed in the Japanese publication No. 10-329346, a mark recording region for recording sector control information is essentially provided on an ink ribbon. Consequently, the ink ribbon fails to be used efficiently by just the mark recording region much.

Furthermore, it is essential to control each of sectors provided for each of yellow, magenta and cyan panels. In other words, in order to control each of the sectors, it is essential to punch a hole or like in the mark recording region and to detect the punched hole.

As mentioned above, in the printing method according to the prior art, there exists a problem such that complicated processes are essential to the printing method so as to use an ink ribbon efficiently.

### SUMMARY OF THE INVENTION

Accordingly, in consideration of the above-mentioned problems of the prior art, an object of the present invention is to provide a printing apparatus for printing an image on a printing object on the basis of input data comprising: a printing mechanism for compressing an ink ribbon against a printing object and forming an image in accordance with input data on the printing object; a controlling section for controlling the printing mechanism so as to form an image rotated by 180 degrees for second printing that is conducted in succession to first printing for printing a not rotated image; and a driving mechanism for rewinding the ink ribbon extended between a supply roll and a take-up roll to the supply roll during the first printing and the second printing.

According to another aspect of the present invention, there provided a controlling method for a printing apparatus, which prints by compressing an ink ribbon against a printing object, comprising the steps of: first printing for printing an image in accordance with input data on the printing object; rewinding the ink ribbon extended between a supply roll and a take-up roll to the supply roll side; and second printing for forming an image in accordance with the input data rotated by 180 degrees on the printing object and for reuse the ink ribbon rewound to the supply roll side.

Other object and further features of the present invention will be apparent from the following detailed description when read in conjunction with the accompanying drawings.

### BRIEF DESCRIPTION OF THE DRAWINGS

FIG. 1 is a block diagram of a printing apparatus according to the present invention.

FIG. 2 is an explanatory drawing of a printing process according to a first embodiment of the present invention for controlling the printing apparatus shown in FIG. 1.

FIG. 3 is an explanatory drawing of a printing process according to a second embodiment of the present invention for controlling the printing apparatus shown in FIG. 1.

FIG. 4(a) is a plan view of image data to be printed on a first card, wherein the image data is arranged in a regular direction.

FIG. 4(b) is a plan view of image data to be printed on a second card, wherein the image data is rotated by 180 degrees with respect to the image data shown in FIG. 4(a).

FIG. 4(c) is a plan view of image data on a Y (yellow) panel of an ink ribbon, wherein two image data for the first and second cards are arrange reversely with each other.

FIG. 5 is a flow chart of a data processing method for detecting whether or not images overlap with each other.

FIG. 6 is a plan view of the printing apparatus showing a card reversing mechanism.

FIG. 7 is a perspective view of a mechanism enabling to revolve a direction of a card selectively.

FIG. 8 is an explanatory drawing of printing process of discrimination information according to the prior art.

### DETAILED DESCRIPTION OF THE INVENTION

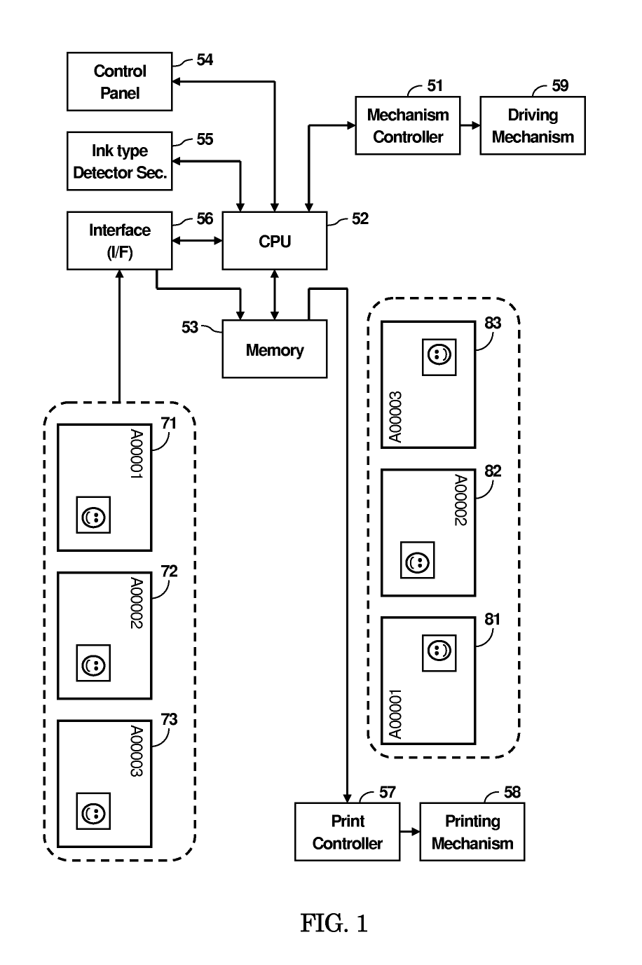

With referring to FIGS. 1-7, a printing apparatus and a controlling method for the printing apparatus according to first and second embodiments of the present invention are described in detail.

First of all, descriptions are given to the printing apparatus common to the first and second embodiment. In following descriptions and drawings, an item or subject matter having a same reference sign substantially exhibits the same functions or contents.

A printing apparatus according to an embodiment of the present invention is a thermal transfer type printing apparatus that utilizes an ink ribbon having a plurality of color panels such as yellow, magenta, cyan and black, for example. Hereafter, it is described as an example that discrimination information is printed on a card such as an ID card as information inherent in the card.

Further, the embodiment of the present invention depicts a printing apparatus of re-transfer printing method in which an image formed on a re-transfer film is re-transferred to a card after the image has been formed on the re-transfer film.

Firstly, a printing apparatus forms an image of discrimination information on a re-transfer film. In other words, the printing apparatus selectively transfers inks on an ink ribbon to a re-transfer film in accordance with printing data. Then the image formed on the re-transfer film is re-transferred to a card in a re-transferring section of the printing apparatus.

More specifically, the card is faced toward the re-transfer film formed with an image, and then the card and the re-transfer film are compressed against each other by a device such as a heat roller. By the compressing process, the image formed on the re-transfer film is re-transferred to the card.

Further, in case a laminating film is compression bonded on the re-transferred card by a device such as a heat roller in a laminating apparatus furnished in a subsequent stage of the printing apparatus, a protective film provided on the laminating film is separated from a base sheet of the laminating film, and the separated protective film is laminated on the surface of the re-transferred card. Consequently, the protective film protects the image re-transferred on the card, and resulting in improving its image quality.

Accordingly, the printing apparatus according to the present invention enables to produce a discrimination card such as an ID card in higher image quality.

With referring to FIG. 1, a printing apparatus according to the present invention is described in detail.

FIG. 1 is a block diagram of a printing apparatus according to the present invention.

In FIG. 1, the printing apparatus is composed of a mechanism controller 51, a CPU (Central Processing Unit) 52, a memory 53, a control panel 54, an ink type detector section 55, an I/F (interface) 56, a print controller 57, a printing mechanism 58 and a driving mechanism 59.

The I/F 56 is connected to an external equipment such as a computer. Printing data from the external equipment is inputted into the memory 53 through the I/F 56. Hereupon, first to third printing images A0001-A0003 are transmitted from the external equipment as first to third input data 71-73 every time printing. The first to third input data 71-73 are inputted into the I/F 56 from the external equipment in order.

Further, each of the first to third input data 71-73 is a file of image data such as bit map data.

More specifically, when a user selects the first printing image A0001 and conducts printing by operating a computer as the external equipment, the first input data 71 corresponding to the first image data A0001 is inputted into the memory 53 through the I/F 56. Similarly, in case the user conducts printing of the second and third image data A0002 and A0003, the second and third input data 72 and 73 respectively corresponding to the second and third image data A0002 and A0003 are inputted into the memory 53. The memory 53 stores the first to third input data 71-73 until the printing process is completed.

The CPU 52 reads out the first input data 71 stored in the memory 53, and supplies first output data 81 corresponding to the first input data 71 to the print controller 57. The print controller 57 controls the printing mechanism 58 on the basis of the first output data 81. The printing mechanism 58 is equipped with a thermal head and so on, and conducts a prescribed printing process.

More specifically, the thermal head is compressed against a re-transfer film from a back surface of an ink ribbon and an element of the thermal head is selectively heated. By the heating, ink on the ink ribbon is melted or sublimated, and the melted ink is thermally transferred to the re-transfer film. By the above-mentioned transferring process, a preferred image enables to be formed on the re-transfer film.

Further, the CPU 52 supplies a prescribed control signal to the mechanism controller 51. By the control signal, the mechanism controller 51 controls the driving mechanism 59. The driving mechanism 59 is equipped with a supply roll and a take-up roll for an ink ribbon, and drives the supply and take-up rolls so as to rotate. The driving mechanism 59 drives the ink ribbon extended between the supply roll and the take-up roll so as to move reciprocally.

Furthermore, the driving mechanism 59 supplies a re-transfer film. By the above-mentioned configuration of the driving mechanism 59, the re-transfer film and the ink ribbon is in such a state that they confront with each other. The printing mechanism 58 thermally compresses the ink ribbon against the re-transfer film while the ink ribbon and the re-transfer film are in the confronting state. As mentioned above, the driving mechanism 59 links to the printing mechanism 58, and they operate in conjunction with each other. By the linking operation between the driving mechanism 59 and the printing mechanism 58, ink is transferred to the re-transfer film in a sequence of yellow, magenta, cyan and black.

Accordingly, an image corresponding to the first printing image A0001 is formed on the re-transfer film.

More, in the printing apparatus according to the embodiment of the present invention, an even numbered printing image out of a plurality of printing images to be printed on respective cards is printed as an image reversed in direction or rotated by 180 degrees. For instance, when the first and second printing images A0001 and A0002 are sequentially printed, an even numbered printing image, that is, the second printing image A0002 is rotated by 180 degrees, and then printed. In other words, an odd numbered printing image, that is, the first printing image A0001 is printed without rotating 180 degrees, and the second (even number) printing image A00002 is rotated by 180 degrees, and then printed.

Consequently, the CPU 52 rotates the second (even number) input data 72 that is read out from the memory 53, and then the CPU 52 outputs the rotated image data to the print controller 57 as second output data 82. As shown in FIG. 1, an image of the second output data 82 corresponding to the second input data 72 is rotated by 180 degrees in comparison with images of the first and third output data 81 and 83 respectively corresponding to the first input data 71 and the third input data 73. The CPU 52 produces the second output data 82 by rotating 180 degrees with respect to the second input data 72.

Accordingly, printing images of which direction is alternately rotated by 180 degrees enables to use an ink ribbon efficiently. Hereupon, rotating 180 degrees denotes that the upper side of an image is rotated so as to be the down side. In other words, the image is rotated by 180 degrees so as to be upside down.

The ink type detector section 55 detects an ink type of an ink ribbon. Detecting an ink type enables to detect that any color ink of yellow, magenta, cyan and black is thermally transferred to a re-transfer film.

Further, in case of discriminating a type of an ink ribbon for the purpose of controlling the printing process, transferring operations enable to be optimized. It is also possible to discriminate a type of an ink ribbon manually. For instance, a user enables to preset a type of an ink ribbon through the control panel 54 or by means of external activation through the I/F 56.

Furthermore, in case an ink ribbon is provided with a discriminating function such as a tag, a type of an ink ribbon enables to be automatically discriminated inside the printing apparatus.

### First Embodiment

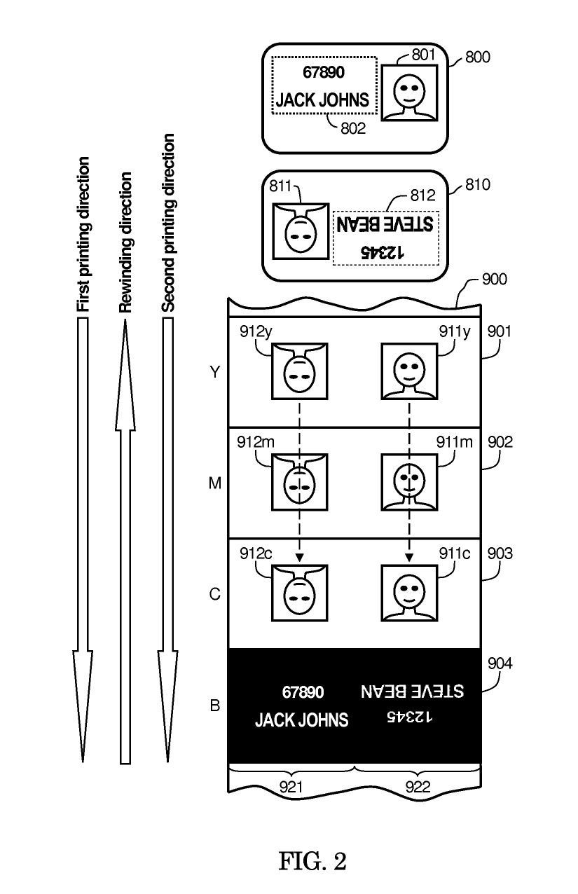

With referring to FIG. 2, a controlling method of the printing apparatus enabling to use an ink ribbon efficiently according to a first embodiment of the present invention is described in detail next.

FIG. 2 is an explanatory drawing of a printing process according to the first embodiment of the present invention for controlling the printing apparatus shown in FIG. 1.

In FIG. 2, graphic layouts of two cards are illustrated in the right upper potion of the drawing and an ink ribbon is shown underneath the card layout. Hereupon, it is depicted that two cards 800 and 810 are sequentially printed as an example. A first card 800 and a second card 810 is an ID card, for example, a facial photograph, a name and a discrimination number is printed thereon. In the first card 800, a name “JACK JOHNS” and a discrimination number “67890” is inscribed thereon. In the second card 810, a name “STEVE BEAN” and a discrimination number “12345” is inscribed thereon. The second card 810 is illustrated upside down in FIG. 2. It is assumed that a printing image of the first card 800 is inputted into the memory 53 through the I/F 56 as the input data 71 and a printing image of the second card 810 is inputted as the input data 72 hereupon.

All of a facial photograph, a name and a discrimination number are transferred to a re-transfer film as discrimination information. The discrimination information is inherent in a card and varies by each card.

Further, a graphic layout of the second card 810 is almost the same as that of the first card 800. In other words, a position on a card in which a facial photograph is printed is approximately the same with respect to each card. Similarly, a position on a card in which character information is printed is approximately the same with respect to each card. Consequently, in case the first and second cards 800 and 810 are arranged in the same direction and piled up, the facial photographs overlap each other and the character information also overlaps each other.

Hereupon, an image of a facial photograph is formed by color printing process and an image of character information is formed by black-and-white printing process. In this regard, it is defined that an area printed with a facial photograph is a color printing area 801 and another area printed with character information is a black-and-white printing area 802.

On the other hand, an ink ribbon 900 is provided with a Y (yellow) panel 901, an M (magenta) panel 902, a C (cyan) panel 903 and a B (black) panel 904. Each of the Y panel 901, the M panel 902 and the C panel 903 is used for color printing. And the B panel 904 is used for black-and-white printing. Consequently, each of the Y panel 901, the M panel 902 and the C panel 903 is used for printing a facial photograph and the B panel 904 is used for printing character information. The Y panel 901, M panel 902, C panel 903 and B panel 904 is soaked with yellow ink, magenta ink, cyan ink and black ink respectively. Each of the Y panel 901, the M panel 902, the C panel 903 and the B panel 904 is repeatedly disposed on the ink ribbon 900 in order. A size of each panel is approximately the same as each other.

The driving mechanism 59 supplies the ink ribbon 900 so as to be overlapped with a re-transfer film in a sequence of Y panel 901, M panel 902, C panel 903, and B panel 904. The size of each panel is similar to or slightly larger than a size of the card 800. Four panels of Y, M, C and B are used for printing on one card as one set of ink. The printing mechanism 58 thermally transfers the one set of ink to the re-transfer film in a sequence of supplied four panels.

Referring back to FIG. 2, description is given to a printing process of a card.

Firstly, first printing is conducted to the first card 800. In other words, ink on the ink ribbon 900 is thermally transferred to a re-transfer film in a sequence of Y, M, C and B. In the thermal transferring process, only a limited part of each panel is actually used for the thermal transferring.

More specifically, in each of the Y panel 901, the M panel 902 and the C panel 903, only a limited part of a panel corresponding to a facial photograph, that is, corresponding to the color printing area 801 is used. Consequently, first used areas 911y, 911m and 911c (hereinafter generically referred to as first used area 911) are formed on the Y panel 901, the M panel 902 and the C panel 903 respectively. In FIG. 2, the first used area 911 is included in the right half plane of each panel. In other words, the left half plane of each of the Y panel 901, the M panel 902 and the C panel 903 is not used for printing the first card 800, and remained as a not-used area.

Similarly, only a limited part of the B panel 904 corresponding to character information, that is, corresponding to the black-and-white printing area 802 is used for actual printing. In this connection, a first used area 921 is formed on the B panel 904. The first used area 921 is included in the left half plane of the B panel 904. In other words, the right half plane of the B panel 904 is a not-used area that is not used for printing the first card 800.

Secondly, the driving mechanism 59 rewinds the supply and take-up rolls. Rewinding the supply and take-up rolls makes each of the Y panel 901, the M panel 902, the C panel 903 and the B panel 904, which is used for the first printing, face toward the re-transfer film once again. In other words, each of the Y panel 901, the M panel 902, the C panel 903 and the B panel 904 is returned to an upstream side of the printing mechanism 58. An image to be printed on the second card 810 is disposed so as to be reversed in direction or so as to be rotated by 180 degrees hereupon.

More specifically, in case the first card 800 is printed in a regular direction, that is, topside of the first card 800 is placed upward as shown in FIG. 2, the second card 810 is printed in a reverse direction. In other words, at the second printing, an image of which direction is reversed upside down with respect to a center of the image is printed on the second card 810. Consequently, the color printing area 811 of the second card 810 is disposed in the left side of the second card 810 and the black-and-white printing area 812 is disposed in the right side of the second card 810.

Then, the second printing is conducted as the same manner as the first printing. Hereupon, a part corresponding to the color printing area 811 of the second card 810 on the Y panel 901, the M panel 902 and the C panel 903 is second used areas 912y, 912m and 912c (hereinafter generically referred to as second used area 912) respectively. As shown in FIG. 2, the second used area 912 is included in the left half plane of each panel. Consequently, the second used area 912 never overlaps with the first used area 911 in each panel. In other words, the left half plane of each panel that is not used for color printing on the first card 800 as the not-used area is used for color printing on the second card 810. In this regard, printing quality is prevented from deteriorating even though each of the Y panel 901, the M panel 902 and the C panel 903 on the ink ribbon 900 is reused.

Similarly, a second used area 922 corresponding to the black-and-white printing area 812 is formed on the right half plane of the B panel 904. Consequently, the second used area 922 never overlaps with the first used area 921 on the B panel 904. In other words, only the right half plane of the B panel 904 that is the not-used area for black-and-white printing on the first card 800 is used for black-and-white printing on the second card 810. In this regard, printing quality is prevented from deteriorating even though the B panel 904 on the ink ribbon 900 is used once again.

Further, an ink ribbon enables to be reused without controlling whether or not the ink ribbon is used. Consequently, an ink ribbon enables to be efficiently and easily used.

As mentioned above, in the printing apparatus according to the present invention, the printing mechanism 58 compresses the ink ribbon 900 against a re-transfer film and forms an image corresponding to input data on the re-transfer film.

Further, the print controller 57 controls the printing mechanism 58 such that images corresponding to respective input data of a first printing and a second printing are reversely arranged in direction and formed.

Furthermore, the driving mechanism 59 rewinds the ink ribbon 900, which is extended between the supply roll and the take-up roll, to the supply roll after the first printing before the second printing. Controlling the driving mechanism 59 as mentioned above enables to use the ink ribbon efficiently. More specifically, each panel on the ink ribbon enables to be used for printing on two cards. One roll of ink ribbon enables to be used a plurality of times without using a special ink ribbon.

More, printing by alternately rotating each image for each card by 180 degrees enables to conduct printing process to cards as many as approximately twice the regular printing process. In other words, one set of Y, M, C and B panels enables to be used for printing on two cards.

Moreover, it is possible to reduce total usage of ink ribbons, so that environmental burden enables to be improved.

As mentioned above, a not-used area of each panel on an ink ribbon enables to be used for next printing, so that the ink ribbon enables to be used efficiently.

In the above-mentioned descriptions, a re-transfer printing type printing apparatus is depicted. However, it should be understood that the above-mentioned printing method enables to be applied for a direct printing type printing apparatus.

In addition, it should also be understood that the above-mentioned printing process enables to be applied for any printing method using any type of ink ribbon other than the ink ribbon 900 containing four-color panels of Y, M, C and B.

Further, in the above-mentioned descriptions, in case of printing on an even number card, an image to be printed on the even number card is rotated by 180 degrees or reversely arranged in direction and then printed thereon. However, it is not necessary to rotate 180 degrees an image for an even number card.

More specifically, it is acceptable that an image to be printed on an even number card is not rotated by 180 degrees and another image to be printed on an odd number card is rotated by 180 degrees.

Furthermore, it is also acceptable that an image is rotated by 180 degrees at every plural card. For instance, when first printing is conducted to first and second cards, images not rotated by 180 degrees are printed thereon, and the ink ribbon 900 is rewound by two sets of panels of Y, M, C and B, and then second printing is conducted to third and fourth cards by using rotated images that are rotated by 180 degrees.

In addition thereto, when rewinding the ink ribbon 900, there is a worry that the ink ribbon 900 may crease. Therefore, it is preferable that a rewinding amount of the ink ribbon 900 during the first printing and the second printing shall be small.

Accordingly, it is most preferable that a rotated image is printed on every other card.

### Second Embodiment

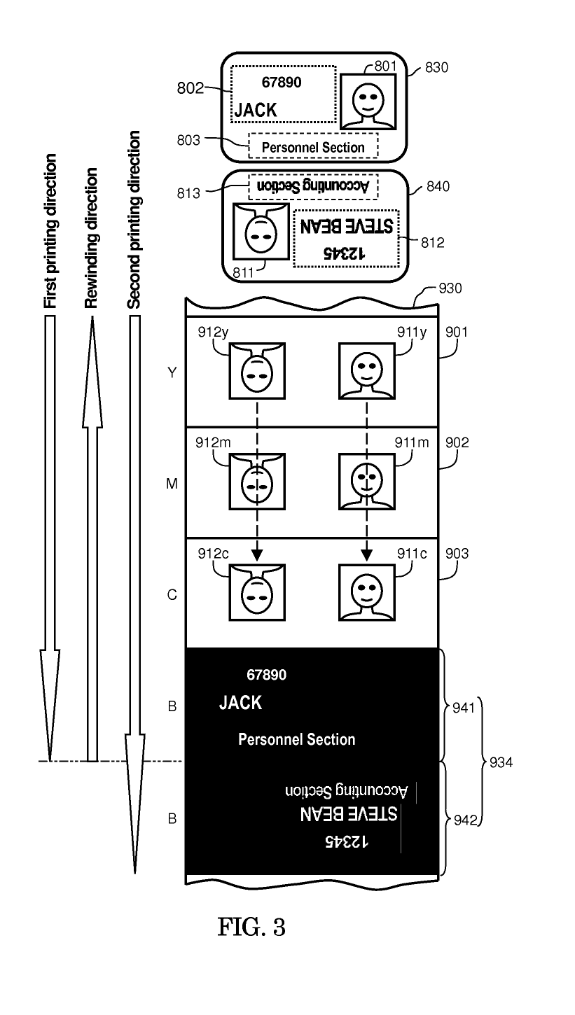

With referring to FIG. 3, a controlling method of the printing apparatus enabling to use an ink ribbon efficiently according to a second embodiment of the present invention is described in detail next.

FIG. 3 is an explanatory drawing of a printing process according to the second embodiment of the present invention for controlling the printing apparatus shown in FIG. 1.

The printing process according to the second embodiment is identical to the printing process according to the first embodiment except for a graphical layout on a card. Consequently, the same component or subject matter as the printing process according to the first embodiment is denoted by the same reference sign.

As shown in FIG. 3, black-and-white printing areas 803 and 813 are added with respect to the first and second cards 800 and 810 according to the first embodiment. With respect to a first card 830, hereupon, the black-and-white printing area 803 is disposed under the facial photograph or the color printing area 801.

Further, a graphic layout of a second card 840 is identical to that of the first card 830. The second card 840 is provided with the black-and-white printing area 813. As shown in FIG. 3, the second card 840 is rotated by 180 degrees or arranged upside down as the same manner as the second card 810 in FIG. 2.

In the first card 830 according to the second embodiment of the present invention, the black-and-white printing area 802 is disposed in the left half plane and the other black-and-white printing area 803 is widely disposed under the color printing area 801 and the black-and-white printing area 802. In other words, the black-and-white printing areas 802 and 803 are arranged in such a layout as expanding into whole plane of the B panel 904 totally. Consequently, in case an image to be printed on a card is rotated by 180 degrees and printed on the card for the purpose of reusing an ink ribbon 930, a used area of the rotated image overlaps with another used area of not rotated image. That is to say, a first used area to be used for printing the black-and-white printing areas 802 and 803 on the first card 830 overlaps with another used area used for printing the black-and-white printing areas 812 and 813 on the second card 840. In this case, the black-and-white printing areas 802, 803, 812 and 813 overlap with each other, so that picture quality of the black-and-white printing is possibly degraded. Consequently, an area of a B panel 934 is enlarged so as to prevent the used areas from overlapping with each other. More specifically, the B panel 934 on an ink ribbon 930 is enlarged approximately twice as much as the B panel 904 on the ink ribbon 900 according to the first embodiment. In other words, in the second embodiment, the ink ribbon 930 is a Y-M-C-B-B type ink ribbon or contains five color panels in total.

By enlarging an area of the B panel 934 as mentioned above, a first used area 941 never overlaps with a second used area 942. As shown in FIG. 3, an upstream side half area of the B panel 934 is the first used area 941 and a downstream side half area is the second used area 942. In the B panel 934, the black-and-white printing to be conducted to the second card 840 is initiated at a point exceeding the first used area 941. By the above-mentioned configuration of the B panel 934, the first used area 941 never overlaps with the second used area 942 on the B panel 934, so that image quality of the printing enables to be prevented from degradation.

Further, the color printing using the Y, M and C panels 901-903 is the same manner as that of the first embodiment, so that the Y, M and C panels 901-903 enable to be reused, and resulting in improving usable efficiency of the ink ribbon 930 more.

Controlling method of the printing apparatus according to the second embodiment is depicted next.

Firstly, first printing is conducted to the first card 830 as the same manner as the first printing on the first card 800 according to the first embodiment. When the first printing is completed, the driving mechanism 59 rewinds the supply and take-up rolls as the same manner as the first embodiment. Then, color printing for second printing is conducted to the second card 840 by using the Y panel 901, the M panel 902 and the C panel 903 as the same manner as the first embodiment. By the above-mentioned color printing method according to the second embodiment, the Y, M and C panels 901-903 on the ink ribbon 930 enable to be used efficiently.

On the other hand, when conducting the second black-and-white printing to the second card 840 by using the B panel 934, a prescribed amount of the ink ribbon 930 is preliminarily forwarded without printing. In other words, the ink ribbon 930 is forwarded as much as the first used area 941 or more. By the preliminary forwarding the ink ribbon 930, the first used area 941 in the B panel 934 is never reused. The preliminary forwarding is realized, for instance, such that the driving mechanism 59 forwards the ink ribbon 930 as much as the size of the second card 840. Preliminary forwarding the ink ribbon 930 conducts the second black-and-white printing to be initiated at the point exceeding the first used area 941. Consequently, only a not-used area in the B panel 934, that is, the second used area 942 is used for the second back-and-white printing, so that image quality of the black-and-white printing enables to be prevented from degradation. It is also acceptable as a matter of course that the upstream side half area of the B panel 934 is used for the second printing and the downstream side half area is used for the first printing.

As mentioned above, by expanding only a section of the B panel 904 twice, the Y, M, C panels 901-903 on the ink ribbon 930 enable to be used efficiently.

Further, it is acceptable to provide another B panel in addition to the B panel 904 instead of expanding the B panel 904 twice. In this case, different B panels are used for the first printing and the second printing respectively.

Furthermore, in the case of the B panel 934 mentioned above, the size of the B panel 904 is expanded twice. However, it is also acceptable that size of any color panel other than the B panel enables to be changed in accordance with an image to be printed on a card.

More specifically, it is just necessary to expand a size of a color panel in which a used area overlaps with another used area when one image is rotated by 180 degrees. By expanding a size of a color panel in accordance with an image to be printed, an ink ribbon enables to be used efficiently without degrading printed image quality.

As mentioned in the first and second embodiments, in case a printing area is disposed only in a half plane of a card when a whole area of the card is divided into two planes, one half plane of an ink panel corresponding to the printing area is used for first printing and the other half plane of the ink panel is used for second printing.

It should be understood that a printing layout on a card is not limited to the layouts disclosed in the first and second embodiments. For instance, it is acceptable that both areas for color printing and black-and-white printing are disposed in a same half plane of a card.

Further, it is also acceptable that each of areas for color printing and black-and-white printing are disposed in an upper half plane or a lower half plane of a card respectively.

Furthermore, it is not limited to the printing layout show in FIG. 2 or FIG. 3, wherein the color printing area 801 or 811 is disposed in the right half plane of the card and the black-and-white printing area 802 or 812 is disposed in the left half plane. It is acceptable as a matter of course that the color printing area 801 or 811 is disposed in the left half plane and the black-and-white printing area 802 or 812 is disposed in the right half plane.

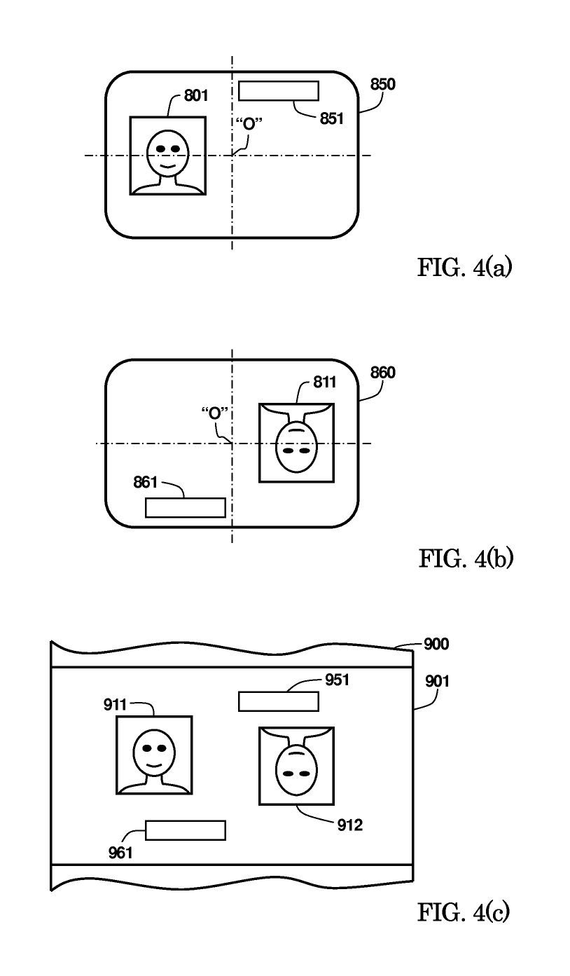

With referring to FIGS. 4(a)-4(c), a printing layout being different from the printing layout mentioned above is described in detail next.

FIG. 4(a) is a plan view of image data to be printed on a first card, wherein the image data is arranged in a regular direction, FIG. 4(b) is a plan view of image data to be printed on a second card, wherein the image data is rotated by 180 degrees with respect to the image data shown in FIG. 4(a), and FIG. 4(c) is a plan view of image data on the Y panel of the ink ribbon, wherein two image data for the first and second cards are arrange reversely with each other.

In FIGS. 4(a)-4(c), only color printing areas are illustrated so as to simplify descriptions.

As shown in FIG. 4(a), two color printing areas 801 and 851 are disposed on a first card 850. The color printing area 801 of the facial photograph is disposed in the middle of the left half plane of the first card 850 and the other color printing area 851 is disposed in an upper right half plane. In this case, two color printing areas are disposed in each half plane on the first card 850 respectively. In case image data is rotated by 180 degrees, a graphic layout of color printing areas results in a graphic layout shown in FIG. 4(b). In FIG. 4(b), two color printing areas 811 and 861 are disposed on a second card 860. By the printing layouts shown in FIGS. 4(a) and 4(b), the color printing areas 801, 811, 851 and 861 do not overlap with each other.

More specifically, the color printing areas 811 and 861 on the second card 860 are shifted from the color printing areas 801 and 851 on the first card 850 in position. Hereupon, rotating 180 degrees the first card 800 with centering a center point “O” results in the graphic layout of the second card 860 shown in FIG. 4(b).

In FIG. 4(c), reference signs 951 and 961 denote used areas corresponding to the color printing areas 851 and 861 respectively.

Consequently, used areas 911, 912, 951 and 961 on the Y panel 901 result in a graphic layout shown in FIG. 4(c). It is apparent from FIG. 4(c) that the used areas 911 and 951 caused by the first printing do not overlap with the used areas 912 and 961 caused by the second printing. It is essential for printing images that one printing image does not overlap with another printing image, which is rotated by 180 degrees with centering a center point of the printing image. Such a printing image layout enables to reuse an ink ribbon easily. In other words, in case printing images are rotated 180 degrees with centering a center point of the printing images, it is required for the printing images to be printed on a card that printing areas of the printing images before rotating 180 degrees do not overlap with printing areas of the rotated printing images.

In the first and second embodiments, it is assumed that the printing data for the first card does not overlap with the inverted printing data for the second card. However, by automatically detecting whether or not printing data overlap with each other, it is possible to prevent printing failure caused by overlapping of the printing data by controlling a printing function so as to be active only when the printing data does not overlap with each other.

Further, in case overlapping of printing data is detected, by notifying the overlapping of the printing data automatically, it is possible to confirm appropriateness of a printing layout previously.

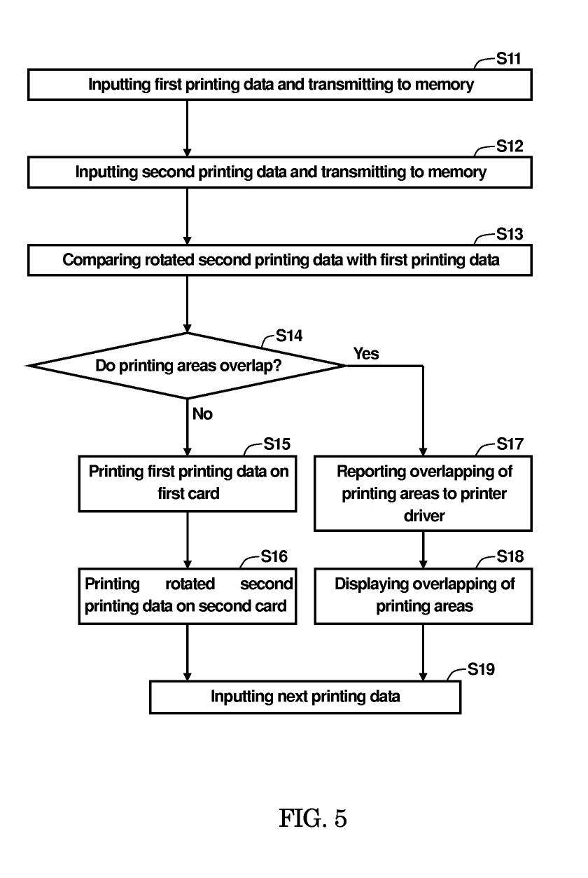

It is possible to detect overlapping of printing images by software such as firmware installed in a printing apparatus. With referring to FIG. 5, a data processing method for detecting overlapping of printing images is described in detail next.

FIG. 5 is a flow chart of a data processing method for detecting whether or not printing images overlap with each other.

Firstly, first printing data for a first card is inputted from an external device and transmitted to the memory 53 (step S11). Secondly, second printing data for a second card is inputted from the external device and transmitted to the memory 53 (step S12). The CPU 52 compares the first printing data with rotated second printing data for the second card (step S13).

More specifically, the CPU 52 produces the rotated second printing data by rotating 180 degrees the second printing data stored in the memory 53, for instance, and then the CPU 52 compares the first printing data stored in the memory 53 with the rotated second printing data.

Further, the CPU 52 judges whether or not the printing areas overlap with each other on the basis of result of comparing the first printing data with the rotated second printing data (step S14).

More specifically, in order to print printing data on two cards, the CPU 52 judges whether or not the first used area 911 for the color printing overlaps with the second used area 912 for the color printing on the ink ribbon900 and the first used area 921 for the black-and-white printing overlaps with the second used area 922 for the black-and-white printing. Thus, the CPU 52 enables to judge whether or not transferring is conducted from a same position on the ink ribbon 900.

In case the CPU 52 judges that printing areas do not overlap with each other, printing the first printing data is conducted to the first card (step S15). In succession to the printing on the first card, printing the rotated second printing data is conducted to the second card on the basis of the second printing data rotated by 180 degrees (step S16). At the time, as mentioned above, the ink ribbon 900 is rewound. By rewinding the ink ribbon 900 to the supply roll, the same ink panels on the ink ribbon 900 enable to be used for the printing on the first card and the second card respectively. When the rotated second printing data is printed on the second card, the step is shifted to a next step S19. In the step S19, printing data for a next card is inputted and the printing process is conducted to the next card as the same manner as mentioned above. In the data processing method mentioned above, the second printing data for the second card is rotated by 180 degrees without rotating the first printing data for the first card. However, it should be understood that the first printing data enables to be rotated by 180 degrees instead of rotating the second printing data 180 degrees.

In case the CPU 52 judges that the printing areas overlap with each other, the CPU 52 reports overlapping of the printing areas to a printer driver of an external device such as a computer (step S17). The printer driver displays the overlapping of the printing areas on a monitor screen of the external device (step S18). By the display, a user enables to recognize that printing the rotated second printing data is disabled. In other words, the user resets the printing layout such that the printing areas do not overlap with each other even though some of them are rotated. Then, the process is shifted to the final step S19.

As mentioned above, the controlling method for the printing apparatus according to the present invention activates a function of using an ink ribbon repeatedly only when printing areas do not overlap with each other.

On the other hand, in case the printing areas overlap with each other, a message such that printing is prohibited is displayed on a monitor screen. Such a data processing method enables to improve convenience of a printing apparatus much more.

In the above-mentioned data processing method according to the present invention, it is depicted as one embodiment that a process of detecting overlapping of printing images is implemented in a firmware installed in the printing apparatus. However, it should be understood that such a function enables to be realized by software installed in a controlling device such as a driver for controlling the printing apparatus.

Further, rotating printing areas by 180 degrees on the basis of image data enables to simplify the process.

Furthermore, it is essential for detecting overlapping of printing areas that positional accuracy of an ink ribbon is carefully considered at a time of controlling the ink ribbon to be rewound. Considering the positional accuracy of an ink ribbon enables to protect two cards of which printing areas overlap with each other from being accidentally printed caused by using same ink panels on the ink ribbon. Consequently, printing quality is prevented from being degraded.

It should be understood that judging whether or not printing areas overlap with each other enables to be conducted to each color basis.

Further, in case a particular ink panel such as the B panel 934 in FIG. 3, for example, is larger than the other panels, it is not necessary to detect whether or not printing areas overlap with respect to the color of the particular ink panel. In this case, by previously designating a color that is not necessary to detect whether or not overlap, detecting whether or not overlap enables to be applied only for predetermined colors other than the designated color.

Furthermore, an IC (integrated circuit) card provided with terminals or contacts for a built-in IC or a previously printed card is acceptable for first and second cards. In case a disposition of an IC in an IC card or an image previously printed on a card is concerned due to its asymmetry, such a problem enables to be overcome by inverting every other card upside down in the vertical direction before printing and loading them into a hopper.

More, it is also acceptable that a card to be printed is rotated by 180 degrees inside a printing apparatus. For instance, in case a direction of a card is previously designated so as to print a printing image on the card by alternately rotating the printing image by 180 degrees as mentioned in the first and second embodiment, it is necessary to print the printing image on each card by inverting a direction of every other card. There are some examples of a card of which direction is previously determined to print such as a card previously printed thereon, a card equipped with a magnetic stripe and a contact type IC card. In case of performing an additional function such as feeding a card and encoding with respect to such a card, it is desirable that cards are arranged in the same direction and every other card is rotated by 180 degrees at the time of printing.

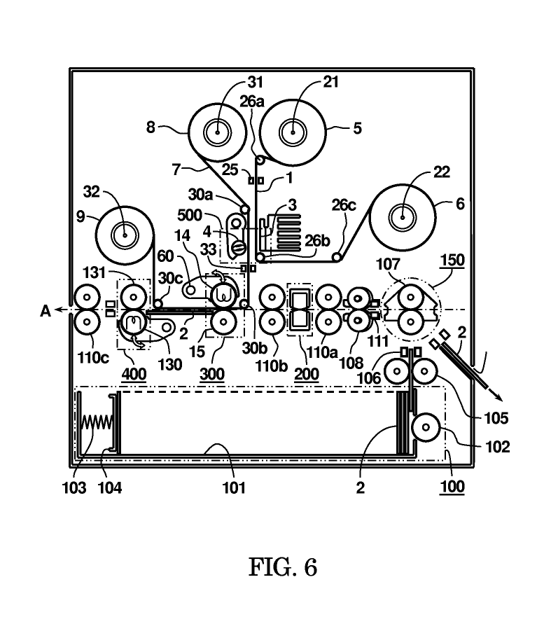

With referring to FIG. 6, a method of changing card direction for the purpose of realizing the above-mentioned printing method is depicted next.

FIG. 6 is a plan view of the printing apparatus showing a card revolving mechanism. A configuration of the printing apparatus shown in FIG. 6 is similar to that shown in FIG. 1 in the U.S. Pat. No. 6,587,135 of which assignee is the same as the present invention. Consequently, constitution of the printing apparatus and its operations are basically similar to those of the U.S. Pat. No. 6,587,135, and a function of encoding an IC card and a card having a magnetic stripe is built-in the printing apparatus.

In FIG. 6, an ink film 1 corresponding to the ink ribbon 900 or 930 is extended between a supply reel 5 and a take-up reel 6 while its surface coated with an ink faces toward a platen roller 4. The ink film 1 is periodically coated with fusible or sublimation type three color inks of yellow Y, magenta M and cyan C or four color inks of yellow Y, magenta M, cyan C and black B as one frame on a base film.

DC motors 21 and 22 are linked to the supply reel 5 and the take-up reel 6 respectively by way of not shown decelerating mechanism as a power source so as to transport the ink film 1. An encoder is built-in the DC motors 21 and 22, so that a rotational angle or a number of rotations of the motors enables to be detected.

The DC motor 21 linked to the supply reel 5 enables to drive the supply reel 5 to rotate in a reverse direction opposite to a regular rotational direction so as to rewind or to apply appropriate back tension to the ink film 1.

Further, constant back tension is always applied to the supply reel 5 by changing voltage supplied to the DC motor 21 in accordance with a remaining amount of the ink film 1 on the supply reel 5. Detecting the remaining amount, that is, a diameter of the wound ink film 1 on the supply reel 5 is calculated by a rotational angle of the DC motor 21 with respect to one frame of the ink film 1 passing through a sensor 25 to be detailed later.

Similarly, the DC motor 22 linked to the take-up reel 6 supplies appropriate extension tension to the ink film 1 by supplying voltage in accordance with a diameter of the wound ink film 1 on the take-up reel 6 at a time of transferring ink on the ink film 1 as well as taking up the ink film 1.

In addition, an encoder built-in the DC motor 21 or 22 controls an amount of transportation of the ink film 1 by detecting the amount of transported ink film 1.

A thermal head 3 is fixed with facing toward an outer surface of the ink film 1, that is, the base film side of the ink film 1 as a first heating section 500. The platen roller 4 is allocated in the opposite side or an ink coated surface side of the ink film 1 so as to contact with or to separate from the thermal head 3. The sensor 25 for cuing the ink film 1 is allocated on a bridging route of the ink film 1 and conducts cuing of the Y ink, for example, on the ink film 1. Cuing a second color or later such as M ink, C ink and B ink is conducted by an encoder built-in the DC motor 21 or the DC motor 22. The sensor 25 is such a sensor that detects a detection mark on the ink film 1 or detects a boundary between adjoining two colors.

Further, the ink film 1 is taken up by the take-up reel 6 by way of guiding members 26a-26c.

An intermediate recording medium 7 is composed of a base sheet in a tape shape, a transparent image receiving layer formed on one surface of the base sheet and a separator layer for separating the transparent image receiving layer from the base sheet. The intermediate recording medium 7 is expanded between a supply reel 8 and a take-up reel 9 while the transparent image receiving layer is faced toward the ink film 1.

A pulse motor or step motor 31 and a DC motor 32 is linked to the supply reel 8 and the take-up reel 9 respectively by way of a not shown decelerating mechanism as a power source so as to transport the intermediate recording medium 7.

Further, an encoder is built-in the DC motor 32 linked to the take-up reel 9 and enables to detect a rotational angle and a number of rotations of the DC motor 32.

The intermediate recording medium 7 is transported from the supply reel 8 to the take-up reel 9 by way of a guiding member 30a, the platen roller 4, a sensor 33 for cuing a frame of the intermediate recording medium 7, a guiding member 30b, between a heat roller 14 and a pressure roller 15 constituting a second heating section 300 and a guiding member 30c in sequence.

Accordingly, ink on the ink film 1 confronts with the image receiving layer of the intermediate recording medium 7 between the thermal head 3 and the platen roller 4 in the heating section 500. The thermal head 3 enables to contact with or to separate from the platen roller 4. Ink on the ink film 1 is thermally transferred to the intermediate recording medium 7 by contacting the platen roller 4 with the thermal head 3. The intermediate recording medium 7 on which the ink is thermally transferred is transported to the second heating section 300 by way of the guiding member 30b.

In the second heating section 300, the heat roller 14 enables to contact with or to separate from the pressure roller 15. The heat roller 14 contacts with or separates from the pressure roller 15 by rotating around an axis of revolution in an arrow direction. When the intermediate recording medium 7 and a card 2 is compressed between the heat roller 14 and the pressure roller 15, the ink transferred to the intermediate recording medium 7 is re-transferred to the card 2. Consequently, the second heating section 300 becomes a printing location for printing on the card 2.

A hopper section 100 contains a plurality of cards 2 corresponding to the cards 800 or 810, which is horizontally arranged in the longitudinal direction.

Further, the hopper section 100 is composed of a case 101 having a gate for the card 2 to be let out one by one, a pickup roller 102 for letting out the card 2, a spring 103 and a pressing board 104, wherein the spring 103 drives the pressing board 104 so as to compress the plurality of cards 2 against the pickup roller 102. The hopper section 100 is constructed so as to be able to draw out to the front side of the printing apparatus.

The printing apparatus is further composed of a pair of cleaning rollers 105 for removing dust possibly adhered on a surface of the card 2 let out from the hopper section 100, a sensor 106 for detecting the card 2 let out from the hopper section 100 and a card revolving section 150 for changing a direction of the card 2 by rotating together with a pair of transporting rollers 107. The card revolving section 150 will be detailed.

Furthermore, in a succeeding stage of the card transporting rollers 107, there is provided with card transporting rollers 108, 110a and 110b and a card ejecting roller 110c. Each of the card transporting rollers 107, 108, 110a and 110b and the card ejecting roller 110c is constituted by a pair of rollers arranged vertically so as to sandwich the card 2. The card 2 is sequentially transported to a next roller in the downstream side or in an arrow “A” direction in accordance with rotation of a pair of rollers, wherein a long side of the card 2 is arranged to be perpendicular to a transporting direction “A”.

The second heating section 300 is provided between the card transporting roller 110b and the card ejecting roller 110c. The card 2 on which an image is re-transferred is transported while the card 2 closely contacts with the intermediate recording medium 7. The card 2 closely contacting with the intermediate recording medium 7 is separated from the intermediate recording medium 7 at the point of the guiding member 30c, and then the card 2 is transported to a warped card correcting section 400. The warped card correcting section 400 is provided with a heat roller 130 and a pressure roller 131 which are similar to the heat roller 14 and the pressure roller 15 in the second heating section 300. The heat roller 130 enables to contact with or to separate from the pressure roller 131.

Further, the heat roller 130 is provided so as to confront with one surface of the card 2 opposite to the other surface on which an image is re-transferred. Heating the card 2 from the opposite side of the image re-transferred surface, thermal deformation of the card 2 caused by heating during re-transferring process in the second heating section 300 enables to be eliminated or reformed. The card 2 passed through the warped card correcting section 400 is ejected externally by way of the card ejecting roller 110c in the arrow “A” direction.

Furthermore, a card detection sensor 111 is provided between the card transporting roller 107 and the card transporting roller 108. When the card detection sensor 111 detects a rear end edge of the card 2, a number of steps of a step motor as a card transporting motor is counted, and then the step motor is ceased from transporting the card 2 at a prescribed number of counts.

More, an encode section 200 is allocated between the card transporting rollers 110a and 110b. The encode section 200 writes information into or reads out information from the card 2 in case the card 2 is an IC card. In this regard, the card transporting operation mentioned above is conducted by the printing mechanism 58 and the driving mechanism 59, which are controlled by the print controller 57 and the mechanism controller 51 respectively. In case an error such as an encode error is happened, the error card 2 is returned to the card revolving section 150 and ejected from an error card ejection slot “D” in an arrow direction.

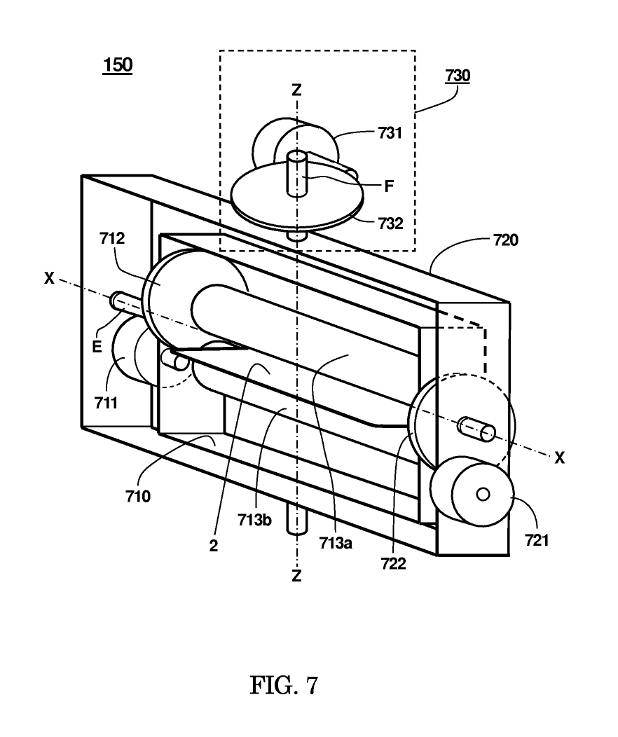

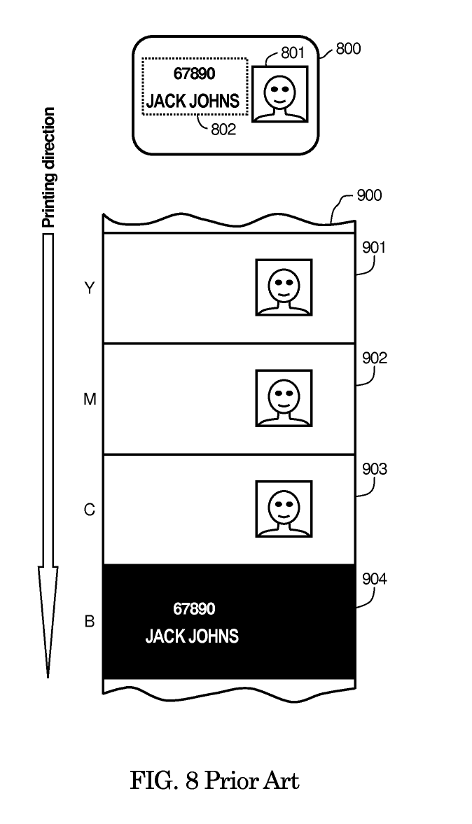

With referring to FIG. 7, a configuration of the card revolving section 150 is described in detail next.

FIG. 7 is a perspective view showing a frame format of the card revolving section 150 enabling to revolve a direction of a card selectively.

In FIG. 7, the card revolving section 150 is composed of a first frame 710, a second frame 720 for revolving a card direction and a card direction changing mechanism 730. The first frame 710 is assembled by card transporting rollers 713a and 713b and a driving motor 711, wherein the card transporting rollers 713a and 713b correspond to the pair of card transporting rollers 107 in FIG. 6. The card transporting rollers 713a and 713b are linked to the driving motor 711 through a deceleration mechanism 712. The deceleration mechanism 712 is realized by combining a plurality of components such as spur gear, worm gear, pulley and belt. The card 2 enables to be transported forward or backward by rotating the driving motor 711 to a forward direction or backward direction.

A motor 721 is mounted on the second frame 720 for revolving a card direction. The motor 721 is linked to the first frame 710 by way of a deceleration mechanism 722 built-in the first frame 710. By rotating the motor 721, the first frame 710 is revolved around a shaft “E” that is rotatably supported by the second frame 720 or around a horizontal axis X-X. Consequently, the card 2 enables to be rotated at a prescribed angle. In other words, one surface of the card 2 enables to be reversed upside down.

Further, the card revolving section 150 provided with the card direction changing mechanism 730 as mentioned above. The card direction changing mechanism 730 is composed of a motor 731 for changing direction and a deceleration mechanism 732. The motor 731 is built-in a not shown main frame and linked to the second frame 720 through the deceleration mechanism 732. By rotating the motor 731, the second frame 720 is revolved around a shaft “F” that is rotatably supported by the not shown main frame or around a vertical axis Z-Z. In this regard, the shaft “F” is supported to be perpendicular to the surface of the card 2 to be printed thereon, so that the card 2 rotates 180 degrees in the horizontal plane. Consequently, a transporting direction of the card 2 enables to be changed in a prescribed angle. For instance, the card 2 enables to be turned upside down.

By changing the card direction as mentioned above, it is possible to print a printing image alternately on a card of which direction is changed with respect to an even numbered card 2 and an odd numbered card 2. In case of a card of which direction is previously determined such as an IC card, a top edge or bottom edge of a printing surface of such a card is preset. By rotating the card 2 around the shaft “F”, a top edge of a printing surface of the card 2 enables to be inverted. For instance, a first card is transported in such a direction that a top edge or upper long side of the printing surface of the card 2 is directed toward the second heating section 300. And a second card is transported in such a direction that a bottom edge or bottom long side of the printing surface of the card 2 is directed toward the second heating section 300. Consequently, every other card enables to be reversely printed in direction. By changing a direction of the printing surface of every other card, appropriate printing enables to be applied for a card of which printing surface is preset in direction such as an IC card and a pre-printed card.

Accordingly, the card revolving section 150 enables to enhance convenience of printing on a card of which direction is preset.

In the printing apparatus shown in FIG. 6, the card 2 is returned to the card revolving mechanism 150 after the card 2 is processed through the encode section 200, and then the card 2 enables to be inverted in direction for printing with respect to every other card by the specific function inherent in the card direction changing mechanism 730. As a result, by inverting a direction of every other card, the printing apparatus enables to eject a plurality of cards of which directions are arranged so as to be in the same direction.

Accordingly, convenience of printing is enhanced furthermore.

Further, in case of arranging each direction of a plurality of printed cards 2 when ejecting the printed cards 2 from the printing apparatus, arranging the directions of printed cards 2 is possibly achieved by returning a printed card of which direction is inverted to the card revolving section 150 and changing its direction, or by providing the card direction changing mechanism 730 in a card ejecting section of the printing apparatus, or by providing the card revolving section 150 in the downstream side of the card ejecting roller 110c. Consequently, a plurality of printed cards enables to be ejected from the printing apparatus in such a way that the directions of the plurality of printed cards are arranged so as to be in the same direction. Thus, convenience of printing is enhanced more. Inverting every other printed card 2 as mentioned above enables to eject the printed card 2 to the outside of the printing apparatus in such a way that directions of the printed cards are arranged to be in the same direction.

Furthermore, with respect to a card of which direction is not designated previously, it is acceptable to eject the card after the card is inversed in direction. Even in this case, all cards enable to be ejected in a state that all cards are arranged to be in the same direction.

Accordingly, convenience of the printing apparatus is enhanced furthermore.

As mentioned above, the present invention enables to provide a printing apparatus in which an ink ribbon enables to be used easily and efficiently, and a controlling method for controlling the printing apparatus so as to be able to use an ink ribbon efficiently.

While the invention has been described above with reference to the specific embodiment thereof, it is apparent that many changes, modifications and variations in the arrangement of equipment and devices can be made without departing from the invention concept disclosed herein. For instance, it is mentioned above that the driving motor 711 and the motor 721 in the card revolving mechanism 150 are respectively mounted on the first frame 710 and the second frame 720, which functions as a movable frame. However, it should be understood that the motors 711 and 721 enable to be built-in the not shown main frame if the motors 711 and 721 are linked with a decelerating mechanism and activated only when the second frame 720 is in a specific position.

It will be apparent to those skilled in the art that various modification and variations could be made in the present invention without departing from the scope or spirit of the invention.

What is claimed is:

1. A printing apparatus for printing an image on a printing object on the basis of input data comprising:
a printing mechanism for compressing an ink ribbon against a printing object and forming an image in accordance with input data on the printing object;
a controlling section for controlling the printing mechanism so as to form an image rotated by 180 degrees for second printing that is conducted in succession to first printing for printing a not rotated image; and
a driving mechanism for rewinding the ink ribbon extended between a supply roll and a take-up roll to the supply roll during the first printing and the second printing.

2. The printing apparatus claimed in claim 1,
wherein the printing object is a card or a re-transfer film for re-transferring an image to a card, and
wherein an image in accordance with the input data is rotated by 180 degrees and printed on every other card.

3. The printing apparatus claimed in claim 2 further comprising a card revolving section for inverting a direction of a printing surface of a card upside down by rotating every other card by 180 degrees before printing.

4. The printing apparatus claimed in claim 2, wherein printed cards are ejected while each printed surface of the printed cards is arranged in the same direction by rotating every other printed card by 180 degrees.

5. The printing apparatus claimed in claim 1,
wherein it is judged whether or not the rotated image for the second printing overlaps with the not rotated image for the first printing, and
wherein the rotated image is printed on a card only when the rotated image does not overlap with the not rotated image.

6. The printing apparatus claimed in claim 1,
wherein the ink ribbon contains a plurality of color panels,
wherein at least one color panel out of the plurality of color panels is larger than other color panels, and
wherein the one color panel in which a second printing area for the rotated image overlaps with a first printing area for the not rotated image is larger than the other color panels.

7. The printing apparatus claimed in claim 1, wherein printing areas in each color panel of the plurality of color panels do not overlap with each other whenever a rotated image rotated by 180 degrees is superimposed on a not rotated image.

8. A controlling method for controlling a printing apparatus, which prints by compressing an ink ribbon against a printing object, comprising the steps of:
first printing for printing an image in accordance with input data on the printing object;
rewinding the ink ribbon extended between a supply roll and a take-up roll to the supply roll; and
second printing for forming an image in accordance with the input data being rotated by 180 degrees on the printing object and for reusing the ink ribbon rewound to the supply roll.

9. The controlling method claimed in claim 8,
wherein the printing object is a card or a re-transfer film for re-transferring an image to a card, and
wherein an image in accordance with the input data is rotated by 180 degrees and printed on every other card.

10. The controlling method claimed in claim 9, wherein a direction of a printing surface of a card is inverted upside down by rotating every other card by 180 degrees before printing.

11. The controlling method claimed in claim 10, wherein printed cards are ejected while each printed surface of the printed cards is arranged in the same direction by rotating every other printed card by 180 degrees.

12. The controlling method claimed in claim 8,
wherein it is judged whether or not the rotated image for the second printing overlaps with the not rotated image for the first printing, and
wherein the rotated image is printed on a card only when the rotated image does not overlap with the not rotated image.

13. The controlling method claimed in claim 8,
wherein the ink ribbon contains a plurality of color panels,
wherein at least one color panel out of the plurality of color panels is larger than other color panels, and
wherein the one color panel in which a second printing area for the rotated image overlaps with a first printing area for the not rotated image is larger than the other color panels.

14. The controlling method claimed in claim 8, wherein printing areas in each color panel of the plurality of color panels do not overlap with each other whenever a rotated image rotated by 180 degrees is superimposed on a not rotated image.
